(19) United States
(12) Patent Application Publication
(10) Pub. No.: US 2006/0154127 A1
(43) Pub. Date: Jul. 13, 2006

(54) Membrane electrode assembly, production method for the same, and proton-exchange membrane fuel cell

(75) Inventors: Shinji Eritate, Tokyo (JP); Motokazu Kobayashi, Tokyo (JP); Zuyi Zhang, Kanagawa-ken (JP); Masayuki Yamada, Tokyo (JP); Teigo Sakakibara, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/559,609

(22) PCT Filed: Sep. 15, 2004
(86) PCT No.: PCT/JP04/13864

§ 371 Date: Dec. 2, 2005

(30) Foreign Application Priority Data
Sep. 30, 2003 (JP) 2003-339798

(51) Int. Cl. H01M 8/10; H01M 4/86; H01M 4/88; B05D 5/12

(52) U.S. Cl. 429/30; 429/42; 427/115; 502/101

(57) ABSTRACT

The membrane electrode assembly of the present invention for the proton-exchange membrane fuel cell includes a polymer electrolyte membrane and an electrode catalyst layer, wherein at least a part of the polymer electrolyte membrane infiltrates into the electrode catalyst layer, and wherein the polymer electrolyte membrane is formed by polymerizing a composition containing at least a compound having proton conductivity and a compound having activity to an active energy ray, or a composition containing at least a compound having proton conductivity and activity to the active energy ray. The object of the present invention is to provide a membrane electrolyte assembly for realizing a high-output proton-exchange membrane fuel cell by improving a bonding state between the polymer electrolyte membrane and the electrode catalyst layer to reduce an internal resistance, and by providing a three-dimensional three-phase interface to increase reaction areas.

### TECHNICAL FIELD

The present invention relates to a membrane electrode assembly for a proton-exchange membrane fuel cell, a production method for the assembly, and the proton-exchange membrane fuel cell using the assembly.

### BACKGROUND ART

A proton-exchange membrane fuel cell uses a reducing agent such as pure hydrogen or reformed hydrogen from methanol or fossil fuel as a fuel, and air or oxygen as an oxidizing agent. The proton-exchange membrane fuel cell consists of: a membrane electrode assembly, which is an assembly of a polymer electrolyte membrane as an electrolyte and a gas diffusion electrode including an electrode catalyst layer, serving as a hydrogen electrode (anode) and an oxygen electrode (cathode); and means for supplying a reducing agent such as pure hydrogen or methanol as a fuel and air or oxygen as an oxidizing agent.

In a proton-exchange membrane fuel cell using hydrogen as a fuel, for example, the following reactions (1) and (2) take place in a negative electrode and a positive electrode, respectively.
Negative electrode: H₂→2H⁺+2e⁻ (1)
Positive electrode: ½O₂+2H⁺+2e⁻→H₂O (2)

Protons generated at the negative electrode pass through the polymer electrolyte membrane and transfer to the positive electrode. If the polymer electrolyte membrane and the electrodes are insufficiently bonded, protons hardly transfer at interfaces between the electrodes and the polymer electrolyte membrane, thereby increasing its internal resistance.

Further, a three-phase interface where a catalytic reaction takes place forms at a bonded interface between the polymer electrolyte and the electrode. The areas of the three-phase interface vary depending on a bonding state of the polymer electrolyte membrane and the gas diffusion electrode including the electrode catalyst layer.

In the proton-exchange membrane fuel cell, a catalytic reaction presumably takes place at the three-phase interface where all of the polymer electrolyte, the electrode catalyst, and a reaction gas (or liquid) exist. Thus, one of important factors affecting an electricity generation performance of the proton-exchange membrane fuel cell is the areas of the three-phase interface of: pores serving as supply paths of the reaction gas; the solid polymer electrolyte having proton conductivity; and catalyst particles, at the interface between the polymer electrolyte membrane and the electrode catalyst layers.

In order to improve the electricity generation performance of the proton-exchange membrane fuel cell, a catalytic reaction site must be three-dimensional for increasing reaction sites. Further, the solid polymer electrolyte must be provided inside the electrode catalyst layers for transferring the protons rapidly.

As an example of the conventional method of producing a membrane electrode assembly, Japanese Patent Application Laid-Open No. H8-106915 proposed a method of sandwiching a solid polymer electrolyte membrane between gas diffusion electrodes including electrode catalyst layers, and hot pressing the whole, to thereby bond the polymer electrolyte membrane and the gas diffusion electrodes including the electrode catalyst layers.

However, the membrane electrode assembly produced according to the conventional production method still has insufficient bonding at interfaces between the polymer electrolyte membrane and the electrode catalyst layers of the gas diffusion electrodes and has an insufficient three-dimensional three-phase interface. Thus, the internal resistance of the fuel cell increases and utilization of the catalyst decreases, whereby sufficient output characteristics of the proton-exchange membrane fuel cell cannot be obtained.

Further, bonding through hot pressing forms substantially flat bonded interfaces between the polymer electrolyte membrane and the electrode catalyst layers of the gas diffusion electrodes. It cannot be said that the bonding strength is sufficient under the electricity generation environment, and the interfaces may be peeled in some cases. Thus, it is necessary to improve the bonding strength between the polymer electrolyte membrane and the electrode catalyst layers.

### DISCLOSURE OF THE INVENTION

The present invention has been made in view of the above-mentioned background art, and an object of the present invention is to provide: a membrane electrode assembly for realizing a high-output proton-exchange membrane fuel cell by improving a bonding state between the polymer electrolyte membrane and the electrode catalyst layer to reduce internal resistance, and forming a three-dimensional three-phase interface to increase the reaction area; and a high-output proton-exchange membrane fuel cell using the membrane electrode assembly.

Further, the present invention provides a method of producing a membrane electrode assembly by which the above membrane electrode assembly can be easily obtained.

That is, a membrane electrode assembly for a proton-exchange membrane fuel cell according to the present invention provides includes at least a polymer electrolyte membrane and an electrode catalyst layer, wherein at least a part of the polymer electrolyte membrane infiltrates into the electrode catalyst layer, and wherein the polymer electrolyte membrane is formed by polymerizing a composition containing at least a compound having proton conductivity and a compound having activity to an active energy ray, or a composition containing at least a compound having proton conductivity and activity to the active energy ray.

A reinforcement member composed of an electrical insulator is preferably provided inside the polymer electrolyte membrane.

Further, the method of the present invention for producing a membrane electrode assembly for a proton-exchange membrane fuel cell, the assembly including at least a polymer electrolyte membrane and an electrode catalyst layer, at least a part of the polymer electrolyte membrane infiltrating into the electrode catalyst layer, comprises the steps of: coating the electrode catalyst layer with a composition containing at least a compound having proton conductivity and a compound having activity to an active energy ray, or a composition containing a compound having proton conductivity and activity to the active energy ray, to form a precursor layer of the polymer electrolyte membrane composed of the composition, at least a part of the composition infiltrating into the electrode catalyst layer; and polymerizing the composition by irradiating the precursor layer with the active energy ray, to form a polymer electrolyte membrane at least a part of which infiltrates into the electrode catalyst layer.

The electrode catalyst layer preferably has a thickness of 0.01 to 200 μm; and an infiltration amount of the composition into the electrode catalyst layer is preferably equal to or smaller than the thickness of the electrode catalyst layer.

The polymer electrolyte membrane is preferably provided with a reinforcer of an electrical insulator inside the membrane.

Further, the present invention provides a proton-exchange membrane fuel cell employing the membrane electrode assembly.

According to the present invention, a membrane electrode assembly having a polymer electrolyte membrane at least a part of which infiltrates into an electrode catalyst layer can be formed by irradiating with an active energy ray a composition containing at least a compound having proton conductivity and a compound having activity to the active energy ray, or a composition containing at least a compound having proton conductivity and activity to the active energy ray. Thus, a bonding state between the polymer electrolyte membrane and the electrode catalyst layer improves to reduce its internal resistance, and a three-dimensional three-phase interface is provided to increase reaction areas, thereby providing a high-output membrane electrode assembly.

Further, the present invention can provide a production method for a membrane electrode assembly by which the membrane electrode assembly can be easily obtained.

Further, the present invention can provide a high-output proton-exchange membrane fuel cell employing the membrane electrolyte assembly.

### BRIEF DESCRIPTION OF THE DRAWINGS

FIG. 1 is a partial schematic view showing a proton-exchange membrane fuel cell of the present invention; and

FIG. 2 is a schematic view showing a bonded surface of an electrode catalyst layer and a polymer electrolyte membrane of a membrane electrode assembly of the present invention.

### BEST MODE FOR CARRYING OUT THE INVENTION

Hereinafter, the present invention will be described in detail with reference to the drawings.

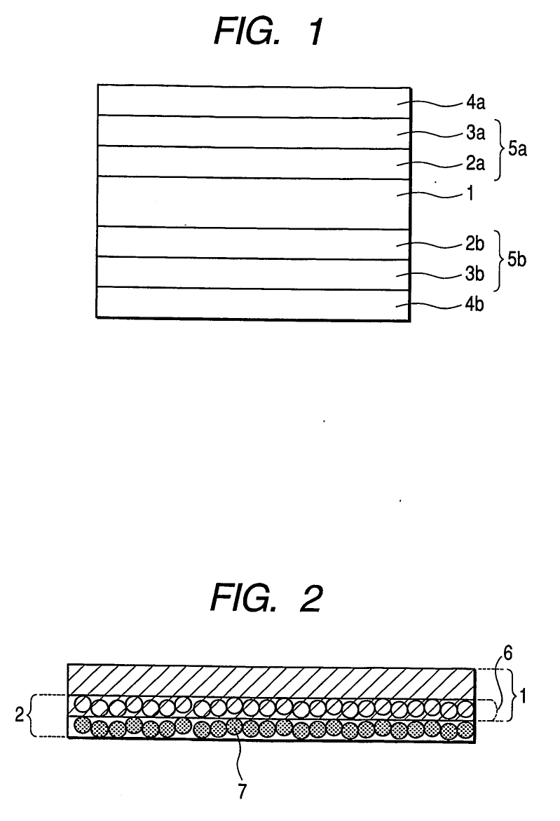

FIG. 1 is a partial schematic view showing an example of a proton-exchange membrane fuel cell of the present invention.

In FIG. 1, the proton-exchange membrane fuel cell of the present invention includes: a polymer electrolyte membrane 1; electrode catalyst layers 2a and 2b on both sides of the polymer electrolyte membrane 1; diffusion layers 3a and 3b on the outsides of the electrode catalyst layers 2a and 2b; and electrodes 4a and 4b serving as a collector and a separator on the outsides of the diffusion layers 3a and 3b.

In the present invention, an assembly of the polymer electrolyte membrane 1, the electrode catalyst layers 2a and 2b, and the diffusion layers 3a and 3b is referred to as “membrane electrode assembly”. Further, each of gas diffusion electrodes is an assembly of the diffusion layer and the electrode catalyst layer, that is, a pair 5a of the electrode catalyst layer 2a and the diffusion layer 3a, and a pair 5b of the electrode catalyst layer 2b and the diffusion layer 3b.

FIG. 2 is a schematic view showing a bonded surface of the electrode catalyst layer 2 and the polymer electrolyte membrane 1. The membrane electrode assembly of the present invention has such a feature that a part of the polymer electrolyte membrane 1 infiltrates into the electrode catalyst layer 2 to form an integrated structure as shown in FIG. 2. Reference numeral 6 denotes an infiltration portion where the polymer electrolyte membrane 1 partly infiltrated into the electrode catalyst layer 2. Reference numeral 7 represents conductive carbon supporting a catalyst.

One or both of the electrode catalyst layers 2a and 2b include electrode catalysts containing conductive carbon. The electrode catalyst layer 2a on a fuel electrode side, for example, is formed of an electrode catalyst containing conductive carbon carrying at least a platinum catalyst.

Platinum group metals such as rhodium, ruthenium, iridium, palladium, and osmium, or alloys of platinum and those metals may be used, instead of the platinum catalyst. When methanol is used as a fuel, in particular, an alloy of platinum and ruthenium is preferably used.

A catalyst used in the present invention is preferably carried on the surface of conductive carbon. An average particle size of the carried catalyst is preferably small, specifically in a range of 1 to 10 nm. An average particle size of less than 1 nm provides too high activity for catalyst particles alone, leading to difficulties in handling. An average particle size exceeding 10 nm reduces a surface area of the catalyst to reduce reaction sites, which may deteriorate the activity.

Further, conductive carbon can be selected from the group consisting of carbon black, a carbon fiber, graphite, and a carbon nanotube. An average particle size of conductive carbon is preferably in a range of 5 to 1,000 nm, more preferably in a range of 10 to 100 nm. Further, a specific surface area of conductive carbon is preferably relatively large for carrying the above-mentioned catalyst, and a BET specific surface area thereof is preferably 50 to 3,000 m²/g, more preferably 100 to 2,000 m²/g.

The electrode catalyst layer 2b on an oxidizing agent electrode (cathode) side is formed of a similar electrode catalyst.

The diffusion layers 3a and 3b are coated with the electrode catalyst alone or in combination with a paste prepared by mixing the electrode catalyst with a binder, a polymer electrolyte, a water repellent, conductive carbon, and a solvent, and the coating is then dried.

The diffusion layers 3a and 3b serve to efficiently and uniformly introduce hydrogen, reformed hydrogen, methanol, or dimethyl ether as a fuel and air or oxygen as an oxidizing agent into electrode catalyst layers, and the diffusion layers in contact with electrodes also serve to transfer electrons which contribute to a cell reaction. Generally, a conductive porous membrane is preferable as the diffusion layers, and for example, carbon paper, carbon cloth, and a composite sheet of carbon and polytetrafluoroethylene can be used.

Surfaces and insides of the diffusion layers may be subjected to water repellent treatment with fluorine-based coating before use.

The diffusion layers preferably have a thickness of 0.1 to 500 μm. The diffusion layer having a thickness of less than 0.1 μm shows insufficient gas diffusion and water repellency. The diffusion layer having a thickness exceeding 500 μm undesirably increases its electrical resistance and ohmic potential loss. The diffusion layers more preferably have a thickness of 1 to 300 μm.

The electrode catalyst layers are formed by coating on the surface and in the pores of the diffusion layers. The electrode catalyst layers preferably have a thickness of 0.01 to 200 μm. A thickness of less than 0.01 μm cannot provide an electrode catalyst layer having a catalyst-carrying amount which exhibits sufficient electricity generation performance. Further, the electrode catalyst layer having a thickness exceeding 200 μm significantly reduces a gas diffusion property in the electrode catalyst layers while its electrical resistance increases. The electrode catalyst layers more preferably have a thickness of 0.1 to 100 μm.

A coating amount of a precious metal catalyst such as an alloy of platinum and ruthenium is preferably 0.01 to 10 mg/cm² (as calculated in a precious metal weight per area), more preferably 0.1 to 0.5 mg/cm². A coating amount of less than 0.01 mg/cm² deteriorates the performance, and a coating amount exceeding 10 mg/cm² increases the cost.

Next, a polymer electrolyte membrane is formed by coating a surface of the electrode catalyst layer coated on the diffusion layer with a coating liquid composed of a composition containing at least a compound having proton conductivity and a compound having activity to an active energy ray, or a composition containing at least a compound having proton conductivity and activity to the active energy ray, and then carrying out a polymerization reaction with active energy rays.

Hereinafter, the coating liquid which becomes a polymer electrolyte membrane with irradiation of the active energy ray and composed of a composition containing at least a compound having proton conductivity and a compound having activity to the active energy ray, or a composition containing at least a compound having proton conductivity and activity to the active energy ray will be simply referred to as “coating liquid”.

The compound having proton conductivity is preferably a compound having a functional group such as a sulfonic group, a sulfinic group, a carboxylic group, a phosphonic group, a phosphoric group, a phosphinic group, and a boronic group. Specific examples thereof include: a mixture of a polar polymer such as polystyrene sulfonic acid, polyvinyl sulfonic acid, polyaryl sulfonic acid, poly(meth)acrylic sulfonic acid, poly(meth)acrylic acid, poly(2-acrylamide-2-methylpropane sulfonic acid), polyacrylamide, polyethyleneimine, polyvinyl alcohol, or polyethylene oxide and an inorganic acid such as sulfuric acid, phosphoric acid, or hydrochloric acid; a polymer obtained by introducing a sulfonic group or phosphoric group to a heat resistant polymer such as polybenzimidazole or polyetheretherketone; and a perfluorocarbon-based ion exchange polymer represented by Nafion.

Further, the compound having activity to the active energy ray includes a monomer. Further, it may contain a crosslinking agent, an initiator, and the like.

The monomer includes a functional monomer or an oligomer having at least one hetero atom. Specific examples of the monomer include: (meth)acrylates and di(meth)acrylates having oxyalkylene chains such as ω-methyloligooxyethyl methacrylate; alkyl (meth)acrylates such as methyl methacrylate and n-butyl acrylate; (meth)acrylamide-based compounds such as acrylamide, methacrylamide, N,N-dimethylacrylamide, N,N-dimethylmethacrylamide, acryloyl morpholine, methacrloyl morpholine, and N,N-dimethylaminopropyl(meth)acrylamide; N-vinylamide-based compounds such as N-vinylacetamide, and N-vinylformamide; alkyl vinyl ethers such as ethyl vinyl ether; and multifunctional (meth)acrylates such as trimethylolpropane tri(meth)acrylate, pentaerythritol penta(meth)acrylate, and dipentaerythritol hexa(meth)acrylate.

As a crosslinking agent, at least one multifunctional polymerizable compound can be used by mixing as a copolymer component. Examples of a crosslinking multifunctional polymerizable compound capable of carry out copolymerization include: diacrylates or dimethacrylates of polyalkylene glycol having a molecular weight of 1,000 or less (such as oligoethylene oxide, polyethylene oxide, oligopropylene oxide, and polypropylene oxide); diacrylates or dimethacrylates of linear, branched, or cyclic alkylene glycol having 2 to 20 carbon atoms (such as ethylene glycol, propylene glycol, trimethylene glycol, 1,4-butanediol, 1,5-pentanediol, 1,6-hexanediol, 1,7-heptanediol, 1,8-octanediol, 1,9-nonanediol, 1,10-decanediol, and cyclohexane-1,4-diol); multifunctional acrylate or methacrylate compounds having a linear, branched, or cyclic polyvalent alcohol having three or more OH groups such as glycerin, trimethylolpropane, pentaerythritol, sorbitol, glucose, and mannite wherein two or more of the OH groups are substituted with an acryloyloxy group or methacryloyloxy group (for example, trimethylolpropane triacrylate (TMPTA), trimethylolpropane trimethacrylate (TMPTM), pentaerythritol triacrylate (PETA), pentaerythritol trimethacrylate (PETM), dipentaerythritol hexaacrylate (DPHA), and dipentaerythritol hexamethacrylate (DPHM)); multifunctional acrylate compounds having a molecular weight of 2,000 or less and having the above-mentioned polyvalent alcohol wherein two or more of the OH groups are substituted with an acryloyloxy-oligo(or poly)ethylene oxy(or propylene oxy) group; multifunctional methacrylate compounds having a molecular weight of 2,000 or less and having the polyvalent alcohol wherein two or more of the OH groups are substituted with a methacryloyloxy-oligo(or poly)ethylene oxy(or propylene oxy) group; aromatic urethane acrylate (or methacrylate) compounds such as a reaction product of tolylene diisocyanate and hydroxyalkyl acrylate (or methacrylate) such as hydroxyethyl acrylate; aliphatic urethane acrylate (or methacrylate) compounds such as a reaction product of aliphatic diisocyanate such as hexamethylene diisocyanate and hydroxyalkyl acrylate (or methacrylate) such as hydroxyethyl methacrylate; divinyl compounds such as divinylbenzene, divinyl ether, and divinyl sulfone; and diallyl compounds such as diallyl phthalate and diallyl carbonate.

Examples of the initiator include: radical thermal polymerization initiators such as azobisisobutyronitrile and benzoyl peroxide; radical photo polymerization initiators such as benzyl methyl ketal and benzophenone; cationic polymerization catalysts such as protonic acids, e.g., CF₃COOH and Lewis acids, e.g., BF₃ and AlCl₃; and anionic polymerization catalysts such as butyl lithium, sodium naphthalene, and lithium alkoxide.

The content of the compound having activity to the active energy ray in the composition is 0.1 to 90 wt. %, preferably 1 to 80 wt. % with respect to the compound having proton conductivity. A content of less than 0.1 wt. % may undesirably result in insufficient polymerization of the composition, and the content exceeding 90 wt. % may undesirably reduce the proton conductivity of the electrolyte membrane.

Further, a compound having proton conductivity and activity to an active energy ray at the same time can be preferably used as well.

Examples of a compound having a sulfonic group include 2-acrylamide-2-methylpropane sulfonic acid, 2-methacrylamide-2-methylpropane sulfonic acid, sulfoethyl methacrylate, 3-allyloxy-2-hydroxy-propanesulfonic acid, p-styrene sulfonic acid, allyl sulfonic acid, and vinyl sulfonic acid. Examples of a compound having a carboxylic acid include acrylic acid, methacrylic acid, crotonic acid, maleic acid, fumaric acid, itaconic acid, and citraconic acid. A fluorine-based monomer or the like can also be used, if required. The above compounds can be used alone, or as a mixture of a plurality thereof.

In particular, a (meth)acrylate derivative having a phosphate group on a side chain can be suitably used. This example is the trade name Phosmer M (acid phosphoxy ethyl methacrylate) commercially available from Uni-Chemical Co., Ltd.).

At least the compound having proton conductivity and the compound having activity to the active energy ray are mixed to thereby prepare the coating liquid.

An appropriate solvent may be added for viscosity adjustment.

Further, a polymer and the like may be dissolved or dispersed in the coating liquid as other additives.

Examples of the polymer include: polyethers such as polyethylene oxide, polypropylene oxide, polytetramethylene oxide, and polyhexamethylene oxide; linear diols such as tetraethylene glycol, hexaethylene glycol, octaethylene glycol, and decaethylene glycol; poly(meth)acrylic acids such as poly(n-propyl (meth)acrylate), poly(isopropyl (meth)acrylate), poly(n-butyl (meth)acrylate), poly(isobutyl (meth)acrylate), poly(sec-butyl (meth)acrylate), poly(tert-butyl (meth)acrylate), poly(n-hexyl(meth)acrylate), poly(cyclohexyl (meth)acrylate), poly(n-octyl (meth)acrylate), poly(isooctyl (meth)acrylate), poly(2-ethylhexyl (meth)acrylate), poly(decyl (meth)acrylate), poly(lauryl (meth)acrylate), poly(isononyl (meth)acrylate), poly(isoboronyl (meth)acrylate), poly(benzyl (meth)acrylate), and poly(stearyl (meth)acrylate); acrylamides such as polyacrylamide and poly(N-alkylacrylamide); vinyl esters such as polyvinyl acetate, polyvinyl formate, polyvinyl propionate, polyvinyl butyrate, poly(vinyl n-caproate), poly(vinyl isocaproate), poly(vinyl octanoate), poly(vinyl laurate), poly(vinyl palmitate), poly(vinyl stearate), poly(vinyl trimethylacetate), poly(vinyl chloroacetate), poly(vinyl trichloroacetate), poly(vinyl trifluoroacetate), poly(vinyl benzoate), and poly(vinyl pivalate); polyvinyl alcohol; acetal resins such as polyvinyl butyral; polyolefins such as polyethylene, polypropylene, and polyisobutylene; and fluorine resins such as polytetrafluoroethylene and polyvinylidene fluoride.

The coating liquid has a viscosity of preferably 0.01 to 20 Pas, more preferably 0.1 to 10 Pas. The viscosity of the coating liquid of less than 0.01 Pas provides too much coating liquid infiltrating into the electrode catalyst layer and may clog the pores of the electrode catalyst layers. The viscosity of the coating liquid exceeding 20 Pas deteriorates fluidity and reduces the amount of the coating liquid impregnated in the electrode catalyst layers.

The coating liquid prepared thus is coated on the electrode catalyst layer to be infiltrated into the electrode catalyst layers.

A coating method is not particularly limited. Specific examples thereof include: batch methods such as bar coating, spin coating, and screen printing methods; and continuous methods such as preweighing and postweighing methods. The postweighing method is a method of coating with an excess coating liquid, and then removing a part of the coating liquid so as to provide a predetermined thickness. The preweighing method is a method of coating with an amount required to provide a predetermined thickness.

Examples of the postweighing method include air doctor coater, blade coater, rod coater, knife coater, squeeze coater, impregnation coater, and comma coater methods. Examples of the preweighing method include die coater, reverse roll coater, transfer roll coater, gravure coater, kiss-roll coater, cast coater, spraying coater, curtain coater, calender coater, and extrusion coater methods. Screen printing and die coating methods are preferable for forming a uniform electrolyte membrane on the electrode layer, and the continuous die coating method is preferable for economical reasons.

The infiltration amount of the coating liquid into the electrode catalyst layers is preferably equal to or less than the thickness of the electrode catalyst layers. The infiltration amount falls more preferably within the range of 1 to 30 μm for increasing a reaction area to provide a high-output proton-exchange membrane fuel cell and for suppressing the cost. Further, the infiltration amount of the coating liquid into the electrode catalyst layers can be adjusted to an arbitrary value depending on the viscosity and coating amount of the coating liquid. Further, the coating liquid may be infiltrated into the electrode catalyst layer by bringing the electrode catalyst layer under a reduced pressure.

The coating thickness of the coating liquid on the electrode catalyst layer surface is 1 mm or less, preferably within the range of 5 to 500 μm calculated as solid contents. The thickness of less than 5 μm provides an electrolyte membrane having minute pinholes and cracks formed easily. The thickness exceeding 500 μm may increase its membrane resistance.

Further, a reinforcement member of an electrical insulator may be provided on the electrode catalyst layer surface and then the coating liquid is impregnated into it, or the reinforcement member impregnated with the coating liquid may be press-bonded on the surface of the electrode catalyst layers, in order to reinforce the electrode catalyst layers and the polymer electrolyte membrane.

The reinforcement member having or not having hydrogen ion conductivity can be used. Any forms of the reinforcement member including sheets, particulates, lines, fibers such as filaments and staples, woven fabrics, and nonwoven fabrics can be used. Sheets, woven fabrics, and nonwoven fabrics are particularly preferable.

The reinforcement member is not particularly limited, and as its material, various resins can be used. Examples of such resins include: fluorine resins such as polytetrafluoroethylene and polyvinylidene fluoride; various polyamide resins such as 6,6-nylon; polyester resins such as polyethylene terephthalate; polyether resins such as dimethylphenylene oxide and polyetheretherketone; and copolymers of α-olefins such as ethylene and propylene, alicyclic unsaturated hydrocarbons such as norbornene, and conjugated dienes such as butadiene and isoprene. For example, polyethylene resins and polypropylene resins; and aliphatic hydrocarbon resins of elastomers such as ethylene-propylene rubber, butadiene rubber, isoprene rubber, butyl rubber and norbornene rubber, and hydrogenated elastomers thereof can be used. These resins may be used alone or in a mixture of two or more kinds thereof.

The reinforcement member may be subjected to a hydrophilic treatment by suitable conventional means. Such a reinforcement member treated with the hydrophilic treatment can be obtained by using a polymer having a hydrophilic group such as a sulfonic group, a phosphoric group, a carboxyl group, an amino group, an amide group, and a hydroxyl group or a mixture thereof as a raw material to form a film for the reinforcement member. Also, the reinforcement member treated with the hydrophilic treatment can be obtained by forming a film of a polymer without such a hydrophilic group and then subjecting the film to, for example, sulfonation treatment.

Further, a polymer electrolyte membrane such as Nafion membrane (available from DuPont) separately prepared may also be used.

Further, an upper side of an electrode catalyst layer may be coated with the coating liquid, and another electrode catalyst layer may be press-bonded on the coated side, to thereby provide a structure of the coating liquid sandwiched by the two electrode catalyst layers. Alternatively, the two electrode catalyst layers may be provided so as to sandwich a reinforcement member between these layers.

Next, the thus-produced stack of the electrode catalyst layers and the coating liquid is irradiated with an active energy ray to simultaneously carry out formation of a polymer electrolyte membrane through a polymerization reaction of a composition in the coating liquid and bonding between the polymer electrolyte membrane and the electrode catalyst layers.

Examples of the active energy ray that can be used include electron beams, gamma rays, plasma, ultraviolet rays, and X-rays.

Electron beams, X-rays, and gamma rays are preferable because the ray reaches inside of the stack of the electrode catalyst layers and the coating liquid and because irradiation equipment thereof costs relatively low, thereby allowing reduction in process cost. Electron beams and X-rays are particularly preferable because irradiation of the rays is easy and its cost is low. Electron beams are most preferable because of high polymerization efficiency of monomers through irradiation. Examples of an electron beam source include various electron beam accelerators such as a Cockcroft-Walton accelerator, a Van de Graaff accelerator, a resonance transformer accelerator, an insulated core transformer accelerator, a linear accelerator, a dynamitron accelerator, and a high frequency accelerator.

An amount of electron beam irradiation is not particularly limited, but is set to preferably 100 Gy to 10 MGy, more preferably 1 kGy to 1 MGy, particularly preferably 10 kGy to 200 kGy. The amount of less than 100 Gy results in insufficient polymerization of the composition in the coating liquid. The amount exceeding 10 MGy may result in a fragile polymer electrolyte membrane cross-linked three-dimensionally.

The acceleration voltage of the electron beams varies depending on a thickness of the electrolyte membrane. The acceleration voltage for a film having a thickness of about several to several tens μm is preferably about 100 kV to 2 MV, and for a film having a thickness of 100 μm or more is preferably about 500 kV to 10 MV. The accelerating voltage may be further increased when metals or the like are included in a mold to block the electron beams. A plurality of electron beams having different accelerating voltages may be irradiated. Further, the accelerating voltage may be changed during electron beam irradiation.

Of energy rays, electron beams are particularly transmitted well through organic substances and therefore permeatted to the inside, thereby providing an electrolyte membrane sufficiently bonded to the electrode catalyst layer.

Further, if required, a heat treatment may be performed on the electrode catalyst layer coated with the coating liquid during irradiation of an active energy ray and/or the formed electrolyte membrane after. Further, after forming the polymer electrolyte membrane, the membrane may be subjected to treatment such as hot pressing in order to enhance bonding between the layers and the membrane.

A proton-exchange membrane fuel cell of the present invention is produced by using a membrane electrolyte assembly produced as above, and stacking the polymer electrolyte, electrode catalyst layers, diffusion layers and electrodes as shown in FIG. 1. A shape of the proton-exchange membrane fuel cell is arbitrary. Further, a production method thereof is not particularly limited, and a conventional method can be used.

### EXAMPLE 1

Hereinafter, the present invention will be described by way of Examples and Comparative Examples, but the present invention is not limited thereto.

(Production of Electrode Catalyst Layer)

Carbon paper (TGP-H-30, available from Toray Industries, Ltd.) having a thickness of 0.1 mm and subjected to water repellency treatment was used as a diffusion layer. A paste prepared by sufficiently mixing 1 g of carbon carrying a 60 wt. % Pt—Ru catalyst (Pt:Ru=1:1, atomic ratio) (available from Tanaka Kikinzoku Kogyo K.K.) and 5 g of a 5 wt. % Nafion solution (available from Sigma-Aldrich Co.) was used as an electrode catalyst layer of an anode side (negative electrode). Carbon paper was coated with the catalyst paste to a predetermined thickness using a bar coater, and then was dried under a reduced pressure at room temperature.

Carbon paper subjected to water repellency treatment was also used as a diffusion layer of a cathode side (positive electrode). A paste prepared by sufficiently mixing 1 g of carbon carrying a 60 wt. % Pt catalyst (available from Tanaka Kikinzoku Kogyo K.K.) and 5 g of a 5 wt. % Nafion solution was used as an electrode catalyst layer of an anode side (negative electrode). Carbon paper was coated with the catalyst paste to a predetermined thickness using a bar coater, and then was dried under a reduced pressure at room temperature.

(Coating Liquid)

Bis(methacryloyloxy) ethyl diphosphate (trade name P-2M, available from Uni-Chemical Co., Ltd.) was used.

(Reinforcement Member)

As Examples of the reinforcement member, a nylon mesh (mesh 508, available from Tokyo Screen Co., Ltd.) having a thickness of 70 μm, a screen opening of 20 μm, and a wire diameter of 30 μm; a porous PTFE film (Microtex NTF, available from Nitto Denko Corporation) having a thickness of 15 μm; and Nafion 115 (available from DuPont) having a thickness of 130 μm were used.

(Production of Membrane Electrode Assembly)

The surface of an electrode catalyst layer was coated with the coating liquid to a predetermined thickness calculated as solid contents using a bar coater. Then, another electrode catalyst layer was press-bonded onto the coated surface.

When the reinforcement member was used, the reinforcement member was coated with the coating liquid to a predetermined thickness calculated as solid contents using a bar coater. Then, the reinforcement member was press-bonded with two electrode catalyst layers.

The stack of the electrode catalyst layers and the coating liquid was irradiated with electron beams of 150 kGy at an accelerating voltage of 150 kV using electron beam irradiation equipment (Eye electron beam EC250/15/180L, manufactured by Iwasaki Electric Co., Ltd.), to thereby obtain a membrane electrode assembly. The membrane electrode assembly was produced as shown in Table 1.

TABLE 1

| | |
|---|---|
| | Thickness of polymer |
| Thickness | electrolyte membrane |
| of | (as solid contents) (μm) |

| | electrode | Inside | Outside | |
|---|---|---|---|---|
| | catalyst | electrode | electrode | Rein- |
| | layer | catalyst | catalyst | forcement |
| Example | (μm) | layer | layer | member |
| Example | 80 | 20 | 80 | Nylon |
| 1 | | | | |
| Example | 10 | 0.5 | 200 | None |
| 2 | | | | |
| Example | 180 | 170 | 30 | PTFE |
| 3 | | | | |
| Example | 240 | 220 | 100 | Nafion 115 |
| 4 | | | | |

(Note:)
Thicknesses of the electrode catalyst layers and polymer electrolyte membrane as solid contents were measured through SEM observation of a section of the membrane electrode assembly after production thereof.

### COMPARATIVE EXAMPLE 1

A nylon mesh having a thickness of 70 μm, a screen opening of 20 μm; and a wire diameter of 30 μm was coated with bis(methacryloyloxy) ethyl diphosphate using a bar coater. The mesh was irradiated with electron beams of 100 kGy at an accelerating voltage of 150 kV using electron beam irradiation equipment, to thereby obtain a polymer electrolyte membrane having a thickness of 100 μm. Carbon papers having electrode catalyst layers (electrode catalyst layer thickness: 200 μm) for the anode and the cathode were arranged on both sides of the polymer electrolyte membrane, and the whole was hot pressed at 90° C. and 9.8 MPa for 10 minutes, to thereby obtain a membrane electrode assembly.

The membrane electrode assembly obtained in each of Examples and Comparative Examples was sandwiched between separators, and fuel cell performance was evaluated using a fuel cell evaluation apparatus (manufactured by Toyo Technical Corporation).

A 5 wt. % aqueous methanol solution was supplied to a fuel electrode (anode) side at 10 ml/min, and air under atmospheric pressure was supplied to an oxidizing agent electrode side at 100 ml/min. Electricity was generated while the whole cell was maintained at 75° C.

Table 2 shows a terminal voltage during discharge at a current density of 0.25 A/cm².

TABLE 2

| Example | Terminal voltage (V) |
|---|---|
| Example 1 | 0.41 |
| Example 2 | 0.38 |
| Example 3 | 0.36 |
| Example 4 | 0.35 |
| Comparative Example 1 | 0.29 |

The results of Table 2 show that voltage values between the terminals of Examples are better than that of Comparative Example 1.

In Examples, the electrode catalyst layer is irradiated with active energy rays with the coating liquid infiltrated into the electrode catalyst layer. Thus, a part of the polymer electrolyte membrane is formed inside the electrode catalyst layer to sufficiently form a three-phase interface, thereby presumably improving an output performance of the proton-exchange membrane fuel cell.

### INDUSTRIAL APPLICABILITY

The membrane electrode assembly of the present invention in which at least a part of the polymer electrolyte membrane is infiltrated into the electrode catalyst layer can be formed by irradiating with an active energy ray a composition containing at least a compound having proton conductivity and a compound having activity to the active energy ray, or a composition containing at least a compound having proton conductivity and activity to the active energy ray. Thus, the bonding state between the polymer electrolyte membrane and the electrode catalyst layer improves to reduce its internal resistance, and the three-dimensional three-phase interface is provided to increase a reaction area. Therefore, the membrane electrode assembly of the present invention can be employed for a high-output proton-exchange membrane fuel cell.

The production method for a membrane electrode assembly according to the present invention allows easy production of the above-mentioned membrane electrode assembly.

This application claims priority from Japanese Patent Application No. 2003-339798 filed Sep. 30, 2003, which is hereby incorporated by reference herein.

1. A membrane electrode assembly for a proton-exchange membrane fuel cell, comprising a polymer electrolyte membrane and an electrode catalyst layer,
wherein at least a part of the polymer electrolyte membrane infiltrates into the electrode catalyst layer, and
wherein the polymer electrolyte membrane is formed by polymerizing a composition containing at least a compound having proton conductivity and a compound having activity to an active energy ray, or a composition containing at least a compound having proton conductivity and activity to the active energy ray.

2. A membrane electrode assembly according to claim 1, wherein a reinforcement member composed of an electrical insulator is provided inside the polymer electrolyte membrane.

3. A production method for a membrane electrode assembly for a proton-exchange membrane fuel cell, the assembly comprising a polymer electrolyte membrane and an electrode catalyst layer, at least a part of the polymer electrolyte membrane infiltrating into the electrode catalyst layer, the production method comprising the steps of:
coating the electrode catalyst layer with a composition containing at least a compound having proton conductivity and a compound having activity to an active energy ray, or a composition containing at least a compound having proton conductivity and activity to the active energy ray, to form a precursor layer of the polymer electrolyte membrane composed of the composition, at least a part of the composition infiltrating into the electrode catalyst layer; and
polymerizing the composition by irradiating the precursor layer with the active energy ray, to form a polymer electrolyte membrane at least a part of which infiltrates into the electrode catalyst layer.

4. A production method for a membrane electrode assembly according to claim 3, wherein the electrode catalyst layer has a thickness of 0.01 to 200 μm, and an infiltration amount of the composition into the electrode catalyst layer is equal to or smaller than the thickness of the electrode catalyst layer.

5. A production method for a membrane electrode assembly according to claim 3, wherein the composition is coated after a reinforcement member composed of an electrical insulator is provided on the electrode catalyst layer.

6. A proton-exchange membrane fuel cell comprising a membrane electrode assembly for a proton-exchange membrane fuel cell, the membrane electrode assembly comprising a polymer electrolyte membrane and an electrode catalyst layer,
wherein at least a part of the polymer electrolyte membrane infiltrates into the electrode catalyst layer, and
wherein the polymer electrolyte membrane is formed by polymerizing a composition containing at least a compound having proton conductivity and a compound having activity to an active energy, or a composition containing at least a compound having proton conductivity and activity to the active energy ray.
